(19) United States
(12) Patent Application Publication
(10) Pub. No.: US 2026/0300042 A1
(43) Pub. Date: Oct. 1, 2026

(54) SYSTEM AND METHODS FOR MODULAR APPLICATION PROGRAM INTERFACE (API) NAMESPACES

(71) Applicant: Microsoft Technology Licensing, LLC, Redmond, WA (US)

(72) Inventor: Neil Bryan SANDLIN, Snohomish, WA (US)

(73) Assignee: Microsoft Technology Licensing, LLC, Redmond, WA (US)

(21) Appl. No.: 19/094,323

(22) Filed: Mar. 28, 2025

(51) Int. Cl. G06F 9/54

(52) U.S. Cl. CPC G06F 9/541

(57) ABSTRACT

Aspects of the technology disclosed herein are related to implementing modular API namespaces. Modular API namespaces can be configured to have a modular nomenclature that includes API namespaces that are grouped or associated to specified functionalities. Modular API namespaces can be dynamically added and are not required to utilize sequencing rules of semantic versioning. Additionally, aspects of the technology disclosed herein are related to implementing development mechanisms that are designed to leverage the nomenclature and capabilities of modular API namespaces. For example, a querying mechanism for modular API namespace is provided which supports searches for modular API namespace that is based on a development key (e.g., indicating a presence and/or implementation state of the API namespace) which is directed to the modular and dynamic functionality of the APIs (e.g., asynchronous delivery of OS related features within a version release).

### BACKGROUND

Computers can be programmed to perform many types of important functions. Frequently, computer programming is implemented as numerous software components that interact to yield a desired behavior for the computer. Application Program Interfaces (APIs) can be utilized to program functions, including for expansive and evolving software, such as an operating system (OS). For example, APIs can provide a standardized way for applications to interact with the underlying hardware and system services through the OS. However, there are several problems commonly associated with traditional programming with APIs. APIs may behave differently across different versions of software, which may create compatibility challenges when developers need to support multiple software and/or OS versions. Traditional programming with APIs may also lead to modifications that may impact compatibility and/or existing integrations of the software (e.g., modifying return types, altering expected behavior, changing function signatures, versioning conflicts) as newer versions may require significant restructuring of existing code to keep applications functional as the APIs evolve. API sets have been developed to provide reliable, flexible, and consistent mechanisms for developers to interact with software and services in a manner that addresses some of the common drawbacks in traditional programming with APIs, including resolving problems around compatibility and versioning.

It is with respect to these and other considerations that examples have been made. In addition, although relatively specific problems have been discussed, it should be understood that the examples should not be limited to solving the specific problems identified in the background.

### SUMMARY

The summary provided herein is provided to introduce a selection of concepts in a simplified form that are further described below in the Detailed Description section. This summary is not intended to identify key features or essential features of the claimed subject matter, nor is it intended as an aid in determining the scope of the claimed subject matter.

The currently disclosed technology, among other things, provides for the implementation of modular API namespaces. In examples, modular API namespaces are configured to have a flexible nomenclature where API namespaces (also referred to herein as “API sets”) may be grouped and/or associated to specified functionalities rather than being tied to a specific version of the software. Instead of adding new APIs utilizing a semantic versioning model, which involves developers sequentially incrementing numbers corresponding to a version to indicate changes in the software (e.g., software version number incremented to indicate new functionality has been added), modular API namespaces (also referred to herein as “API set groups”) can be added or integrated individually without having to conform to strict sequencing rules associated with a semantic versioning model. The modular API namespaces, as disclosed herein, enable modularity with respect to implementation of components and/or functions of API namespaces. Instead of hard-linking applications to specific dynamic link libraries (DLLs) (which implement the functions and/or components of an API in accordance with the defined capabilities and/or behaviors for the API, the ability to specify modular API namespaces provides a flexible mechanism whereby the components and/or functions are mapped to a “group” of APIs within an API set (e.g., API set group). Thus, modular API namespaces provide a layer of abstraction by decoupling applications and functions from direct dependencies on system dynamic link libraries. At runtime, the modular API namespace links the group of APIs in the namespace to the proper contract (e.g., implementation DLL) in a manner that provides enhanced compatibility with evolving operating systems, increases modularity in API implementation, and decouples APIs from semantic versioning. The disclosed system and techniques are described in reference to APIs, however aspects of the disclosed embodiments are not limited thereto and are applicable to other computer programming structures and/or syntaxes that may be utilized to group, organize, and/or link related software functionalities (e.g., non-API namespace programs).

The details of one or more aspects are set forth in the accompanying drawings and description below. Other features and advantages will be apparent from a reading of the following detailed description and a review of the associated drawings. It is to be understood that the following detailed description is explanatory only and is not restrictive of the embodiments as claimed.

### BRIEF DESCRIPTION OF THE DRAWINGS

The accompanying drawings, which are incorporated in and constitute a part of this disclosure, illustrate various aspects of the present techniques. In the drawings:

FIG. 1A depicts an example environment in which a system for implementing modular application programming interface (API) namespaces may reside, as discussed herein.

FIG. 1B depicts an example software architecture, including a loader, that may be used in implementing modular API namespaces, as discussed herein.

FIG. 2A depicts an example configuration of a mapping of a modular API namespace to a contract, as discussed herein.

FIG. 2B depicts another example configuration of a mapping of a modular API namespace to a contract, as discussed herein.

FIG. 2C depicts another example configuration of a mapping of a modular API namespace to a contract, as discussed herein

FIG. 3 depicts an example method for querying a modular API namespace, as discussed herein.

FIG. 4 is a block diagram illustrating example physical components of a computing device with which aspects of the technology may be practiced.

### DETAILED DESCRIPTION

The following detailed description refers to the accompanying drawings. Wherever possible, the same reference numbers are used in the drawings and the following description to refer to the same or similar elements. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the technology, but instead, the proper scope of the technology is defined by the appended claims. Examples may take the form of a hardware implementation, or an entirely software implementation, or an implementation combining software and hardware aspects. The following detailed description is, therefore, not to be taken in a limiting sense.

As briefly discussed above, operating systems (OSes) may utilize API namespaces (also referred to herein as “API sets”) to provide OS components with mechanisms to virtualize module names to aid in refactoring. As utilized herein, “refactor” may refer to restructuring and/or updating existing code of an API namespace, for example, in a manner that may or may not alter the external functions and/or capabilities of the software. An OS may include capability to author and consume optional API components according to a formal pattern. However, some systems utilize a semantic versioning nomenclature for API namespaces. As utilized herein, a “semantic versioning nomenclature” may refer to a naming convention that involves developers using numbers to correspond to a version of the software and sequentially increasing the numbers to indicate changes in the software (e.g., software version number incremented to indicate new functionality has been added). For example, examples of changes to software utilizing a semantic versioning nomenclature may include:
Version v1.0.0→Version v2.0.0 (indicating a major software change that may impact compatibility, such as format, removing parameters, or renaming an endpoint, etc.).
Version v1.1.0→Version v1.2.0 (indicating a minor change that may involve adding new functionality without impacting compatibility, such as adding an optional feature, updated parameter, etc.)

The semantic versioning nomenclature has been relatively unchanged and over the years has been increasingly unable to accurately represent the presence of new features (e.g., unreleased), or detect a new feature that is activated for use by an end user (e.g., implemented, released). In some cases, an OS may have the capability to continuously have components and functionalities updated and/or added, which may stretch API models that utilize the semantic versioning nomenclature to its breaking point. In addition, aspects of developer redesigns to improve the OS may be restricted due to the limited compatibility associated with the semantic versioning nomenclature (e.g., a major software change that may revert to a previous version of the software).

An API set infrastructure, at an OS layer, can provide multiple fundamental functions, including, but not limited to: a central, consistent mechanism to refactor software editions and binaries into smaller, decomposed units, while handling unavailable features at runtime; a mechanism to break dependencies on legacy “big cycle” desktop binaries and allow those dependencies to be satisfied in light-weight editions; a widely used application compatible (e.g., app-compat) layer (e.g., reverse forwarders) for broader application support, allowing third-party binaries to seamlessly benefit from the refactored software editions; a versioning system for down-level compatibility to maintain the functionality of previous binaries included in an API over time; a light-up mechanism that allows for optional features to be dynamically enabled by the API (e.g., at runtime), both in desktop and smaller editions; and/or the like.

Infrastructure for API sets has evolved over the years for various purposes, including splitting an OS into smaller units. Implementing API sets may realize a wide range of advantages and may assist in the proliferation of OS variants in a manner that may optimize the capabilities of a particular OS variant for a specific real-world application (e.g., use case) and/or hardware environment Data for API set usage may include but is not limited to: API set schemas that define the structure, organization, and/or interaction of API endpoints; API set contracts that define the function, structure, and/or rules of interaction for a set of APIs; API set schema extension mechanisms that allow developers to update an existing API schema (without modifying the core functionality); and API set schema extension packages that may include predefined schema extensions that can be applied to an existing API set schema to modify the capabilities.

Technology involving APIs is widely used and provides value and benefit to componentization and packaging of software; however, there are areas where the infrastructure for APIs has lagged with respect to new OS developments. For example, API sets were designed at a time when an OS may be released every few years, and each release was locked into a specific overall set of accessible APIs that were provided by the OS (also referred to herein as an “OS API surface”). The development of an OS utilizing conventional API sets may experience some inflexibility with respect to the construction of releases where new functionality is introduced continually into a current release (e.g., new components and/functions integrated between releases). This inflexibility may even be exacerbated in the event that new functionality and/or components are repeatedly (e.g., continuously), modularly (e.g., incrementally), and/or frequently (e.g., multiple times per year) introduced into a current OS release. In such an evolving OS, where modular delivery of new and/or updated features is supported, an individual feature can be delivered (e.g., “in place”) but not implemented (e.g., disabled) which may not be currently representable in an API set schema.

A release cycle for an OS may no longer be according to simple sequencing but can involve multiple branches to represent any given release cycle. For example, multiple iterations of a new feature may be developed within a single release cycle, and a sequential increment of the software version number may be overly simplified and may not accurately capture the update. As utilized herein, a “release cycle” may refer to a process by which versions, updates, and patches for software, such as an OS, are developed and deployed. In addition, new and/or updated components in the OS may be dynamically enabled for use in a manner that may cause the API set schema, which defines the current endpoints in the API, to become defective (e.g., the API set schema does not include API endpoints reflecting new and/or updated features of the OS). This may cause degradation in infrastructure quality and can impede the components' ability to reliably detect the portion of the OS API surface that is implemented. By detecting the functions and/or portions of the OS API surface that are enabled (e.g., implemented) an OS may provide improve compatibility (e.g., applications only call APIs that are available for the given OS version), increase stability (e.g., mitigate potential application crashes and/or unpredictable behavior), and optimize the overall performance of the OS (e.g., applications can use the most recent and enabled API set). API modular namespaces, as disclosed herein, may address these and other limitations associated with utilizing the semantic versioning nomenclature for API sets to develop an evolving OS.

Additionally, utilizing semantic versioning for contract revisions of API sets may not be optimal for an evolving OS where the features of an application may change dynamically during the same OS version. Unfortunately, semantic versioning may become cumbersome and/or defective in a platform where an API surface can be backported without following any sequential model. As utilized herein, “backporting” may refer to a process that involves making a feature and/or function introduced in a newer version of software available to be utilized in a previous (e.g., older) version of the software. For example, if a particular functionality is available in a version v2.1 of a released product, it may be possible for an update to the functionality that is made available in a subsequent version v2.2 to be backported into the previous version v2.1 A semantic versioning nomenclature may not be suitable to represent this type of backporting. For instance, once released, the shape of a versioned release should be immutable.

Conventional semantic versioning may provide a framework to describe changes and deletions of features and/or functions in the OS API surface. For example, developers may remove a feature from a subsequent release of the OS (e.g., deleting APIs related to the feature from the OS API surface), for instance due to inefficiency (e.g., low usage) and/or detected failures of the feature after deployment. The semantic versioning nomenclature may indicate the deleted feature through a “major version change” by incrementing the major version number for the OS (e.g., changing from version v1.1 to version v2.0). However, changing (or removing) function signatures is generally an infrequent operation because of application compatible considerations. If changes made to a surface of an API were represented over time, utilizing semantic versioning to represent a deleted feature through a “major version change”, for example, it may appear that almost no changes/deletions were made to an already-published OS API surface. That is, semantic versioning may provide value if an OS API surface is serially growing, where new APIs are added over time, and the older OS API surface remains constant. Semantic versioning may be suitable for capturing newly added versions, for example transitioning from version 2.1 to 2.2, where the entire OS API surface in version 2.1 now appears unchanged in the new version 2.2. However, as previously described, semantic versioning may be limited to indicate changes and/or deletions to the OS API surface through “major version change” mechanics. As another example, if there is a version 2.1 of the software including an original OS API surface, and the original OS API surface is changed, then semantic versioning may be utilized for a “major version change” which updates to version 3.0 of the software and may appear as a sequential evolution to the OS where the original OS API surface is unchanged. However, in real-world applications, an OS API surface may rarely evolve sequentially. Therefore, relying on semantic versioning (e.g., major version changes) may unduly restrict changes to the original OS API surface because of compatibility concerns, as the cases where semantic versioning may be suitable are infrequent.

As discussed herein, the embodiments implement modular API namespaces (also referred to herein as “API set groups”) to address limitations that may be related to API namespaces utilizing a semantic versioning nomenclature, among other benefits. Modular API namespaces may be configured to have a modular nomenclature where API namespaces may be grouped and/or associated to specified functionalities rather than being tied to a specific version of the software. Instead of adding new APIs as a strict versioning sequence, modular API namespaces can be added or integrated individually without having to conform to strict sequencing rules in a manner that can replace “minor version” updates in the semantic versioning model while adding flexibility. Modular API namespaces are not tied to the mechanics of “collapsing” all edits of a contract for each OS release, which may involve maintaining the entirety of the OS API surface of previous OS releases (as defined by the contract) in subsequent OS releases. Instead, modular API namespaces can be individually authored over any given development cycle and retain their identity regardless of forks in development of the OS or the components (e.g., libraries, dependencies, configuration) that are included in a version of the OS at a previous release point (e.g., fixed release snaps). Additionally, the embodiments implement development mechanisms that are designed to leverage the distinct nomenclature and capabilities of modular API namespaces. As discussed herein, a querying mechanism for modular API namespaces is provided. The querying mechanism, which supports searches for modular API namespaces, can be based on a development key (e.g., indicating a presence and/or implementation state of the API namespace) which is directed to the modular and dynamic functionality of the APIs (e.g., asynchronous delivery of OS related features within a version release).

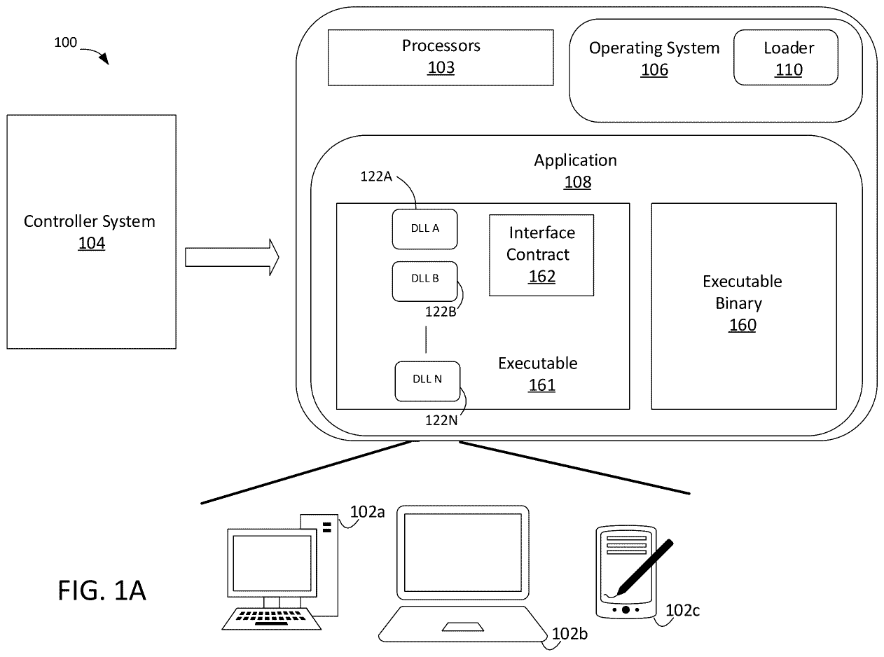

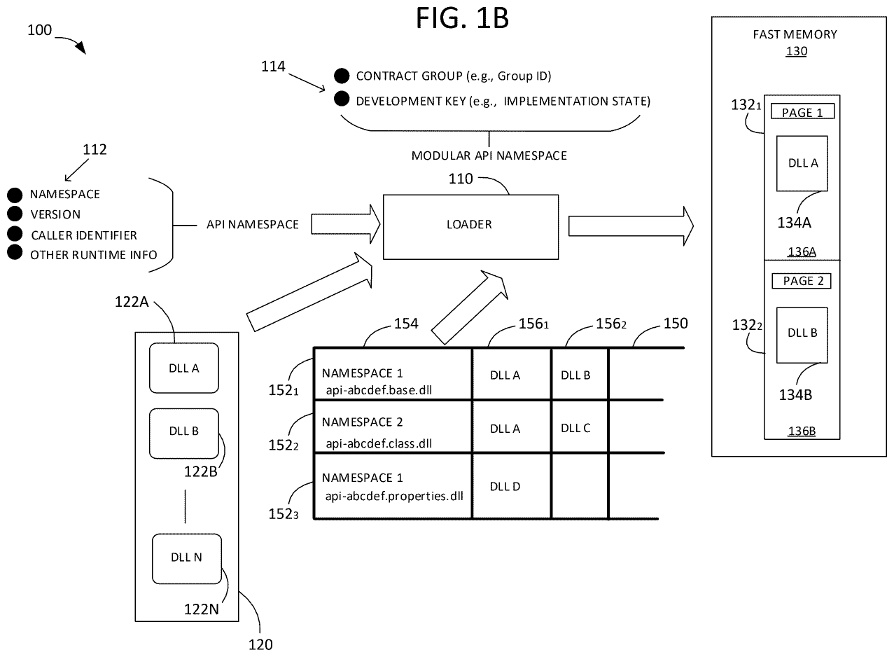

In FIG. 1A, a computer system environment 100 is depicted, which may be configured to implement the modular API namespaces (also referred to herein as “API set groups”) as discussed herein. The computer system environment 100 may include a controller system 104 in communication with a computer system 102 that may be implemented as one or more computer devices, shown in FIG. 1A as PC/desktops 102a, laptop 102b, tablet/smart device/smart phone 102c. FIG. 1A illustrates examples of computer system 102, but the embodiments disclosed herein are not limited thereto. Computer system 102 may include one or more processors 103, an operating system 106, and at least one application 108 which may be actuated by a user or the computer system itself. The controller system 104 may be a remotely located computer device that is configured for managing computer hardware and/or software operations of the computer system 102, including updating the operating system 106. The controller system 104 may be a computer system equipped with a processor, memory, and communication interface, which is operatively connected to the computer system 102 via a communication network, such as wide area network (WAN). In some embodiments, the controller system 104 may function with a computer device (e.g., server) hosting OS update packages and facilitates the secure download and installation of the OS update to the computer system 102. In an operational example, a user (e.g., a software developer) may employ the controller system 104 to author and control the distribution of APIs (and associated development keys) for implementing dynamic and/or modular updates to the features of an evolving OS, as described herein.

The application 108 and/or the operating system 106 may contain multiple components. In the example of FIG. 1A, the application 108 is depicted as including the components described in detail herein. In some embodiments, the operating system 108 may include components in addition to and/or in lieu the components of application 108. The components may comprise dynamically linked libraries shown as dynamic link libraries 122A, 122B . . . 122N, binaries shown as an executable binary 160, and/or executables shown as executable 161. A dynamically linked library, for example dynamic link libraries 122A-122N, may have a “.dll” file extension, and the executable 161 may have an “.exe” file extension. For example, the application 108 may include a single executable binary 160 with or without accompanying dynamic link libraries 122A-122N. An executable (.exe), for example executable 161, can refer to API namespaces (shown in FIG. 1B) and/or the target libraries 122A-122N (.dll). A library (.dll) can be the target of an API namespace and also refer to other libraries through API namespaces. When application 108 is launched in computer system 102, the executable binary 160 may be loaded for execution.

A dynamically linked library, for example dynamic linked libraries 122A-122N, may comprise multiple portions containing different types of information needed for computer system 102 to execute functions encoded in the dynamically linked library. Each dynamically linked library 122A-122N may comprise a code portion and a dependency portion. The code portion of each of the dynamically linked libraries 122A-122N may comprise computer-executable instructions that may be executed by one or more processors/controllers of computer system 102. The dependency portion of each dynamically linked library 122A-122N may identify other dynamically linked libraries on which the dynamically linked library may depend for proper operation.

In computer system 102, the dependency portion of the application executable 161 or accompanying dynamically linked libraries 122A-122N within application 108 may be implemented as an import address table identifying dependent dynamically linked libraries by name. However, in accordance with embodiments disclosed herein, some or all of the dependency information may be specified by identifying a modular API namespace (e.g., API set group) against which the code in the associated code portion was developed. The dependency portion, for example, may identify one or more modular API namespaces that define interfaces to functions called from within code in the code portion.

In operation, the dependency information may signify to a loader that dependent dynamically linked libraries should also be loaded to support execution of a dynamically linked library. For example, dependency information may indicate that a dynamically linked library depends, for operation, on a modular API namespace. That modular API namespace may be implemented by one or more dynamically linked libraries within operating system 106, which are loaded when a dynamically linked library is loaded such that instructions within the code portion may access functions implemented by the modular API namespace.

To support such accessing of functions provided by a dynamically linked library, each dynamically linked library 122A-122N may implement an “interface contract.” FIG. 1A depicts an example of an interface contract 162. The interface contract 162 contains information defining the interfaces through which consuming components may access functions performed by that dynamically linked library 122A-122N. For example, an interface contract 162 may be reflected in a header file associated with the dependent dynamically linked library 122A-122N in a development environment. Through a process of compiling the dynamically linked library 122A-122N and loading it, the information in the header file may be translated into programming interfaces upon which other components may place calls when the dynamically linked library 122A-122N is loaded for execution.

A dynamically linked library 122A-122N may indicate that it consumes a particular modular API namespace. The modular API namespace may be mapped to a dependent dynamically linked library within the operating system. In addition, dynamically linked libraries may consume more than one modular API namespace.

The software components may be initially stored in non-volatile memory, such as a hard disk. Such memory can provide persistent storage for a large amount of computer software and data used in operating a computer.

However, a conventional computer system traditionally does not execute software components directly from non-volatile memory. The non-volatile memory may be too slow to allow access to instructions and data as the computer operates. Accordingly, a conventional computer may “load” software components before they are executed so that they can use fast memory. Frequently, some software is loaded each time a computer is powered up. However, not all software is loaded at power up. A computer may be programmed with more software than is used at one time. Accordingly, it is known to dynamically load software components. These components are stored as a file containing computer-executable instructions in a form that can be executed without compiling. These files also may be called “binaries”, “libraries”, or “executables.”

Loading is done by a component of an operating system 108, called a “loader.” FIG. 1A depicts an example of a loader 110. The loader 110 performs multiple operations that are needed to make a binary ready for execution, including allocating fast memory to store computer-executable instructions that make up the binary 160. The loader 110 may also trigger allocation of fast memory to store data accessed by the binary 160.

A library may implement multiple functions, sometimes referred to as a library of functions. The functions implemented in a library may be defined in an “interface contract.” The interface contract 162 defines APIs that can be used to access the functions in the library. Other components may be said to “consume” the interface contract. Once the library is loaded, the consuming components can access, or link to, all of the functions in the library by accessing the functions using interfaces defined in the interface contract. For this reason, a software component that is loaded in this fashion may be called a “dynamically linked library.”

Because the interface contract 162 for a component is known in advance, components consuming the interface contract can be written using APIs defined by that contract so that they can interact with the library. Each dynamically linked library 122A-122N may include an import address table that identifies other dynamically linked libraries that it consumes, which are sometimes referred to as dependent dynamically linked libraries. When one dynamically linked library 122A-122N is loaded, a loader 110 may load the dependent binaries for that library. In some examples, a loader 110 may defer loading dependent binaries until a later time, such as when the dependent binaries are actually accessed.

FIG. 1B depicts an example software architecture for an example configuration of the computer system 102, with mappings between modular API namespaces and components. FIG. 1B illustrates portions of a computer system that may resolve an API namespace to a set of dependent binaries, which are then loaded by the loader 110. In this example, these functions are performed by a loader 110 within an OS. Such a loader 110 may be constructed using techniques as are known in the art. However, rather than operate based on an indication that a dependent dynamically linked library is to be loaded, as is conventional, loader 110 operates on an indication that a modular API namespace 114 is to be loaded.

In some embodiments, the loader 110 may receive an API namespace (e.g., API set) 112 utilizing a versioning nomenclature as an input parameter. As shown, the loader 110 can receive as input an indication that an API namespace 112 is to be loaded. Such an indication may be generated in any suitable way, such as a part of initializing a computer system, in response to an indication that an application should be launched, or in response to operations performed within a component that is already loaded and executing, among other ways.

The API namespace 112 may include one or more suitable parameters and may be in any suitable format. In the example of FIG. 1B, the parameters of the API namespace 112 may include an identifier for the API namespace to be loaded, and an identifier for the version of the API namespace against which a component triggering loading of the API namespace was coded. For example, dependency portions, in addition to identifying the API namespace, may identify a version assigned to a specific set of dependent dynamically linked libraries that implemented that API namespace 112 at the time the respective dynamically linked libraries were coded. As the dependent dynamically linked libraries are changed, the version identifier may also change. Additionally, a numbering scheme may be adopted for the version identifier to differentiate between major and minor changes.

In the semantic versioning nomenclature for API namespace 112, as the API surface of a contract and its corresponding host binary evolves, there can be versioning bumps to record each change. Minor version bumps (e.g. 1.0->1.1->1.2) can track API additions to a contract, where no changes were made to pre-existing members of the contract. Each bump can be representative of a timeline in which each subsequent version is an addition, and the latest revision means that the previous minor versions were also included. Major version bumps (e.g. 1.0->2.0->3.0) can track contract breaking changes, where APIs may be removed, or signatures may be changed. The contract can also allow host binaries to change and coexist, where there can be a distinct host binary for each major version. These bumps may effectively represent a timeline, where a version host (e.g., 3.0) may include features of previous versions (e.g., 1.0, 2.0) of APIs that were removed or changed. Thus, for example, querying the implementation for API namespace 112 associated with a version 1.3 (higher minor version), would indicate that APIs in the API namespace 112 associated with a version 1.2 (lower minor version) is also present, and the query will return true for all revisions in both branches. In some embodiments, any suitable mechanism may be used to identify versions of the set of components that implement the API namespace 112.

As described above, there may be some limitations with an API namespace 112 utilizing the versioning nomenclature. The model of maintaining the API namespace 112 base schemas was made to be based on these released OS versions. During a release cycle, individual changes to API set contracts were effectively treated as a work-in-progress, where changes may be repeatedly merged over the course of development until the next release. Internal variations may not be implemented, and the contracts effectively were snapped only at release to manufacturing (RTM) as a significant event.

In some cases, the modular API namespace 114 may be deemed optimal and/or suitable for the construction, capabilities, and/or servicing of an evolving OS. For example, the OS 106 may enable repeated (e.g., continuous), incremental, and/or modular delivery of updates, new functionality (or features) and/or improved functionality to software products (e.g., applications, platforms, development tools) at times that may be agnostic to version releases. For example, feature updates for a currently released version of the OS 106 may be delivered prior to the release of the subsequent version of the OS 106. This enables the OS 106 to evolve incrementally, rather than relying on major version releases. The modular API namespace 114 (or API set groups) has a nomenclature that can modularly group APIs within an APIset in a manner that is flexible and may be based on developmental characteristics (e.g., features, functions) to be leveraged by the continuous delivery aspects of the OS 106 (e.g., not tied directly the OS version). In some embodiments, the modular API namespace 114 may be identified with a unique identifier, and the groups of APIs can be managed independently from other groups in the contract. The contract author can define several groups in the contract, each with a group (or subset) of APIs. For example, an API namespace may have multiple modular groups of modular API namespaces 114 therein. The name of the modular API namespace 114 can then be used: as part of the generated API set module name; and/or in the API set schema, to be directly queried (e.g., for presence) by the disclosed querying mechanism.

An example of a format for the nomenclature of the modular API namespace 114 can include:
<prefix>-<product>[-<feature area>[-<feature> . . . ]].<group>

The first set of name elements (before “.<group>”) in the nomenclature of the modular API namespace 114 may be referred to as the contract base name, and the group name element (“.<group>”) may be referred to as the contract group. The contract base name may be the portion of the entire contract name which is tied directly to a specific API set host binary. The prefix parameter can be “api”. In some embodiments, the product parameter may be an API set definition that is designed to be reusable for a group of products (e.g., “win” for any Windows®-based product). In some embodiments, the product parameter (e.g., “<product-name>”) can be an API set definition that is designed to only be used on a specific product. The feature area parameter can be defined as a high-level subsystem or features within a line of products that may signify a set of binaries that implement a major feature within the product line. The feature parameter may be defined as a more specific selection of APIs within a given subsystem. A subsystem can contain multiple API set host binaries, and the family name can cover a set of APIs that would not be practical to split across binary implementations (e.g., a family name may account for adding multiple hosts within a subsystem).

There is also a contract group name included in the nomenclature of the modular API namespace 114. The contract base name may define a specific API set host binary, and the contract group name can be an element that can define a subset (or group) of APIs within the API set contract. The nomenclature of the modular API namespace 114 can define an “atomic implementation unit” within the host, which might appear in different contexts: as a minimum (“min”) implementation of functionality; and as a portable unit that could be backported to a previous OS release. The “group” element (or contract group name) enables an author of the API set to control the specification of updates to a contract (e.g., enabling API surface revisions to be created) without regard to OS version. Furthermore, each contract group can be associated with a development key. Introducing new APIs can be accomplished by adding a new ContractGroup element associated with the new functions, which can be implemented at any time during development.

An example syntax of a ContractGroup element in a contract for the modular API namespace 114 can include:
@[ContractGroup(Base)];

In some embodiments, there can be multiple ContractGroup elements within a single contract. As previously discussed, in the syntax of a modular API namespace 114, the ContractGroup element may appear before the APIs in that corresponding group. But the elements may appear anywhere in the contract, after the ContractGroup element. In the above syntax, the group name “base” in this example can be a string that is defined by the creator of the contract to give a short descriptive name for the contract addition. The contract group name can be used within the contract to identify the APIs in the group. For example, the group name “base” may be included at the end of the API set module name. The ContractGroup element may not be structured in the same manner as the semantic versioning nomenclature of API namespace 112 that may include a version revision (e.g., 1-3).

With reference again to FIG. 1B, a controller system 104 can be implemented that supports the modular updating of features and/or components into an evolving OS 106. In some embodiments, the system may have the capability to control aspects of software development, implementation and/or distribution (e.g., software release) of APIs. For example, the system can implement an API set that supports certain features in the OS 106 but may disable the API set which prevents its features from being accessed and/or utilized until they are deemed suitable and/or optimal for full release/integration. Because the system can control the implementation state of APIs, the system can also have the capability to assign (e.g., link) development keys to an API set (and/or API set groups). The development keys corresponding to a modular API namespace, for example, can indicate information related to the software development of the API set (and/or API set groups), such as the implementation state of the APIs in the namespace. By linking a development key to a modular API namespace 114, the system has the capability to dynamically track the current implementation state (e.g., enabled, disabled), for example, of the group of APIs (within the modular API namespace 114) at any phase (e.g., software rollout) and/or version of the OS 106. The development keys can be implemented in this system, and the nomenclature of the modular API namespace 114 also includes development keys for interoperability with this system.

In some embodiments, utilizing the API namespace 112 can support indication of two states of presence relating to APIs. Presence states of the API namespace 112 can include a first state where the host binary for implementation is in the OS image, and a second state where the host binary for implementation is not in the OS image. In contrast, implementing development keys with respect to the modular API namespace 114 can enable APIs to be identified in a more nuanced manner. In some embodiments, development keys included in the nomenclature of the modular API namespace 112 can support indication of at least three states of presence relating to APIs. The implementation states (indicated by development keys) can include, but are not limited to: there is no implementation host binary; there is a host binary, but the implementation is disabled; there is a host binary, and the implementation is enabled.

Support for development keys and the associated functions can be is integrated into a contract for a modular API namespace by specifying one or more attributes in a ContractGroup element. In some embodiments, the syntax can utilize “stagedFeatureHeaderName” and “stagedFeatureClassName” as defined attributes. A corresponding flag value can be incorporated into the API set runtime schema so that it can be used to determine an implementation state for the API set group in the contract. An example syntax of the aforementioned attributes in a ContractGroup element includes:
@[ContractGroup(Base),
stagedFeatureHeaderName(“featurestaging-abc.h”),
stagedFeatureClassName(“Feature_abc_xyz”)];
   The arguments of the attributes can be used to query for the feature key value. In some embodiments, if a feature is set to always enabled (e.g., “AlwaysEnabled”) then the attribute can be deleted from the ContractGroup element. Then the ContractGroup may be evaluated only based on the presence of the API set host binary which is tied to the API set. The querying mechanism configured to utilize modular API namespace 114, as disclosed herein, may consider the host state of the API set contract, as well as the value of the development key for the APIs. A positive return value (e.g., TRUE) from the querying mechanism can indicate that the specified group of APIs in a queried modular API namespace 114 is available via export and enabled.

To support implementation of a modular API namespace 114, a group attribute can be implemented, which may be an attribute that is assigned to a “group” of APIs in an API set. For a given API declaration in the contract, a function can be associated with a contract group by specifying the group name in its metadata declaration. An example syntax of an API declaration, using the group attribute to specify the API set contract group can include:
@[Group(Base)]
BOOL
WINAPI
SetXyzClassProperty(
LPSTR propName,
DWORD propValue);

Multiple group attributes may be specified in an API declaration, but the first may determine which group will be used in the querying mechanism for the API. In some embodiments, individual APIs may not be tracked in the runtime schema, thus specifying multiple groups for an API may not be utilized.

In some embodiments, there are an unlimited number of API groups in a contract. For example, a contract may be authored with each API having its own unique group, with each group gated by an independent development key. However, each group may take a non-zero amount of space in the API set schema. The schema data can be mapped by the kernel into every process at boot. This supports API set resolutions running quickly for both the kernel-mode and user-mode loaders. Accordingly, design tradeoffs, such as flexibility with respect to runtime memory overhead, may be considerations in creating modular API namespaces. For example, a newly created API set contract may contain a single API set group, and over time, new groups of APIs (e.g., API set groups) may be added to the API set as different APIs are defined and added to the contract (or if original APIs are changed or removed).

An example syntax of a modular API namespace 114 can include:
api-win-security-activedirectoryclient.ngc
   The prefix parameter “api” can be a contract name prefix. The product parameter “win” can refer to the contract being relevant to a Windows® edition/product. The feature area parameter “security” can indicate the OS subsystem in which the API set belongs. The feature parameter “activedirectoryclient” can indicate the subsystem family which contains the contract. The Group parameter “ngc” can indicated the contract group, namely the group of the APIs for “NGC Keys”, which may have been implemented separately from the original “ActiveDirectoryClient API”.

The modular API namespace 114 can enable a nomenclature that groups API namespaces based on development characteristics (e.g., features), in a manner that does not rely on semantic versioning such that there is no implied sequence amongst groups. As an example, the modular API namespace 114 can have a contract that has been created named “api-abcdef”, which has been established with two APIs. If the API namespace 112 was employed, the versioning nomenclature may include a “1-0” revision, and the two APIs would have an associated module name with the “1-0” version at the end.

In modular API namespace 114, an author can freely utilize a name of the group of APIs for the nomenclature. As an example, a name “base” may be utilized for the modular API namespace 114 which associates the group of APIs in the namespace to the specified name “base” (associated with the contract “api-abcdef”) Continuing with this example, the group name can be appended to the end of the contract name associated with the modular API namespace 114 to form its module name (e.g., using a character “.”). For example, the modular namespace 114 can utilize “api-abcdef.base.dll” as a name for the group of APIs within the API set (e.g., API set group). This nomenclature utilized for the modular API namespace 114 enables flexibility to modularly update (e.g., add, remove) groups of APIs associated with a particular contract (e.g., API set). For example, two new groups of APIs may be added to the contract (e.g., API set) “api-abcdef”, where a first group of APIs can have a first name “class” and the second group of APIs can have a separate name “properties”. Accordingly, the contract associated with the API set “api-abcdef” can publish the modular API namespace 114 including multiple groups of APIs within the API set, represented as: “api-abcdefbase.dll”; “api-abcdefclass.dll”; and “api-abcdef.properties.dll”.

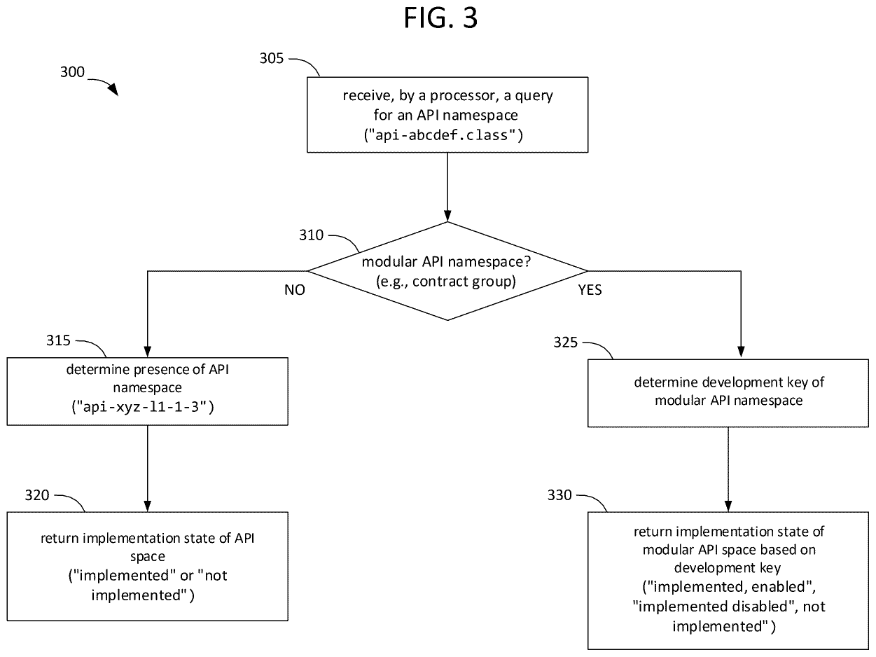

As shown in FIG. 1B, an example of a nomenclature that can be utilized for a modular API namespace 114 includes several parameters, including but not limited to: a contract group (e.g., group identifier) which may act as a name, identifier, and/or other data that may semantically represent and/or identify the group of APIs within the namespace (associated with the contract); and a development key which may represent data related to software development, such as an implementation state, that is associated with the group of APIs in the namespace. In some embodiments, the contract group for the modular API namespace 114 can be a term that is human intelligible, for example a name that indicates the functions implemented by the APIs to be recognized by a human software developer. In some embodiments, the contract group for the modular API namespace 114 may be arbitrary characters (e.g., alphanumeric characters), codewords, and/or secret identifiers that may not be recognizable by humans and/or software, for example randomized characters which obfuscate the functions implemented by the APIs so as to not be intelligible to a hacker. As discussed in greater detail in reference to FIG. 3, the development key of a modular API namespace 114 may be a value that is searchable with respect to the querying mechanism to indicate an implementation state (or presence) of the APIs in the namespace. For example, the querying mechanism may return an implementation state related to the development key of a searched modular API namespace 114, where the development key is a key indicating whether the APIs in the group are enabled or disabled.

A modular API namespace 114 can refer to a respective group of APIs that have functions that are separated in the contract, as they may also be separated in implementation. In some cases, a properties group may be backported to an older branch of the contract, but not the class group. With semantic versioning nomenclature of the API namespace 112, functions to the original 1.0 (base) version may be patched in, or the whole class may be ported. In the modular nomenclature of modular API namespace 114, a properties group can be flexibly moved and/or added to an older version of the contract and not violate versioning rules. As disclosed herein, authors of API namespaces, such as API namespace 112 and/or modular API namespace 114, can include automated and Artificial Intelligence (AI) systems and/or techniques that may automatically generate code and/or functions for development of software. As disclosed herein, the modular API namespace 114 may be utilized for an OS that is configured to enable API namespaces (or API sets) as modular components, representing collections of APIs that may be grouped by functionality (as opposed to the version of the OS).

Any other suitable parameters may be provided as inputs to loader 110. The parameters, for example, may include an identifier of the caller. In this case, the caller refers to a component that depends on the API namespace and has triggered the loading of the API namespace. In the example of FIG. 1B, dynamically linked library 122A is the caller for the API namespace A 112 when namespace A is loaded to support calls from functions made from within dynamically linked library 122A.

Other types of information may also be provided as input parameters for loader 110. This information could include, for example, a hardware configuration, a software configuration or any other suitable runtime information.

Loader 110 may use the input parameters included in nomenclature of the modular API namespace 114 to access a map to identify a group of components and/or features that collectively implement the functions contained within the API namespace identified in parameters of the modular API namespace 114. Here a map 150 is illustrated. Map 150 may be implemented as a data structure stored in memory within a computer system. In the example of FIG. 1B, map 150 is implemented as a data structure with multiple rows, of which three rows, 152₁, 152₂ and 152₃ are shown. Each of the rows maps a modular API namespace 114 to a set of components that collectively implement a namespace associated with the row. In the example of FIG. 1B, three rows are shown for simplicity, but any number of rows may be included in map 150.

In the example of FIG. 1B, the map 150 contains multiple columns, of which columns 154, 156₁ and 156₂ are shown. Each column includes information of a specific type that may be used by loader 110 to resolve a modular API namespace to a set of components. Column 154 contains a contract group (or group ID) of a modular API namespace 114. In the example of FIG. 1B, column 154 includes contract groups discussed in the previous example, “api-abcdefbase.dll”; “api-abcdefclass.dll”; and “api-abcdefproperties.dll”. In operation, loader 110 may match a contract group for a modular API namespace 114 to a row in map 150 based on the values in column 154. For example, the loader 110 may match the contract group “base” (in modular API namespace “api-abcdefbase.dll”) to row 152₁ in map 150.

The remaining columns, illustrated as columns 156₁ and 156₂ in FIG. 1B contain identifiers for components that implement the modular API namespace identified in each row. Here, two columns, 156₁ and 156₂, are shown for simplicity. However, any suitable number of columns may be included in map 150, allowing any suitable number of components to be associated with a namespace through map 150.

Map 150 may be created in any suitable way. In this example, map 150 provides information relating to modular API namespaces supported by a framework, such as an operating system. Accordingly, the information in map 150 may be collected at the time a configuration of an operating system is developed. A tool, for example, may scan the code base for the operating system, collecting references to modular API namespaces and identifying the components that implement functions identified in the interface contract for each modular API namespace. Other approaches for obtaining this information may also be used. For example, implementation of a modular API namespace may be declarative, meaning that a component may declare that it implements a particular namespace contract.

Regardless of how created, the map 150 may then be supplied to computer users in conjunction with the operating system, such that users receiving different configurations of the operating system will receive a map with different information, mapping the same modular API namespaces to different sets of components. Alternatively or additionally, map 150 may be supplied to a computer user as part of a patch that updates an operating system. As an example of another variation, the map may be built or altered dynamically, with vendors that supply software that either consumes specific namespaces or supports additional or alternative namespaces, providing an executable component or other mechanism that modifies or extends the map.

It should be appreciated that the rows and columns of map 150 are a schematic representation of organization of information, indicating graphically related information that may be used to relate components to a namespace. Any suitable organization of information may be used. For example, map 150 may be stored as a schema in any suitable format, such as in an XML file or a database.

Regardless of how map 150 is created or stored, in operation, loader 110 can identify based on the API namespace 112, the modular API namespace 114, and map 150 components to implement an API namespace to be resolved under the current runtime conditions. Once loader 110 identifies the components associated with a modular API namespace to be resolved, loader 110 may load those components using techniques as are known in the art. However, any suitable technique for loading executable components may be used.

In the example of FIG. 1B, the computer system includes nonvolatile memory 120 in which multiple dynamically linked libraries 122A, 122B . . . 122N are stored. Each of the dynamically linked libraries may be stored as a separate file or with any other suitable organization.

Regardless of how the components are stored, when loader 110 resolves a modular API namespace (or group of API sets) identified in utilizing the nomenclature of modular API namespace 114 to a set of components, it obtains those components from nonvolatile memory 120. Loader 110 then creates memory structures in fast memory 130 and otherwise triggers action(s) that make the components ready for execution. Fast memory 130, for example, may be RAM or other suitable memory within a computer system. Any suitable memory structures may be created for each component to be loaded. The memory structures created in fast memory 130 may be memory structures as are known in the art. In this example, loader 110 creates a space in fast memory 130 for each component to be loaded that contains one or more pages. In this example, pages 132₁ and 132₂ are shown, each containing information associated with one loaded component.

The information stored in each page may be information as is known in the art. As an example, the information in page 132₁ may include executable code 134A associated with a component to implement a portion of the functions in the modular API namespace. Page 132₂ may include executable code 134B, which may implement a second portion of the functions in the modular API namespace. Though not expressly illustrated, the pages associated with each of the loaded components may contain different or additional types of information. For example, memory structures may store variables accessed by the components as they are executed, and other information may similarly be stored in the pages allocated for each loaded component.

Applications and other components may reference the modular API namespace 114 in the same way that a dynamically linked library may be referenced. However, the loader 110 may use the map 150 to identify and load the component or components that contain functions that collectively implement the API set group of the modular API namespace, providing access to the functions in the modular API namespace.

The implementation of the modular API namespace 114 is not tied to a particular dynamically linked library, allowing flexibility in the manner in which the functions are implemented and flexibility in the manner in which dynamically linked libraries are maintained. That flexibility is achieved without unacceptable degradation of system performance.

Thus, the loader 110 that maps the modular API namespace 114 to components also enables functions within the namespace to be implemented in different ways depending on runtime conditions. The loader 110 may identify a component to implement functions for a modular group of APIs within the modular API namespace 114 based on one or more parameters, at least some of which may be parameters identifying runtime conditions. Those parameters, for example, may indicate a hardware environment. As a result, an application program calling the modular API namespace 114 need not be coded differently to provide different behaviors in different hardware environments. The application program can access functions using the same interface contract, regardless of environment. Yet, when a function is called, the appropriate behavior for the function may be achieved because the component selected by the loader 110 implements the function as is appropriate for the environment.

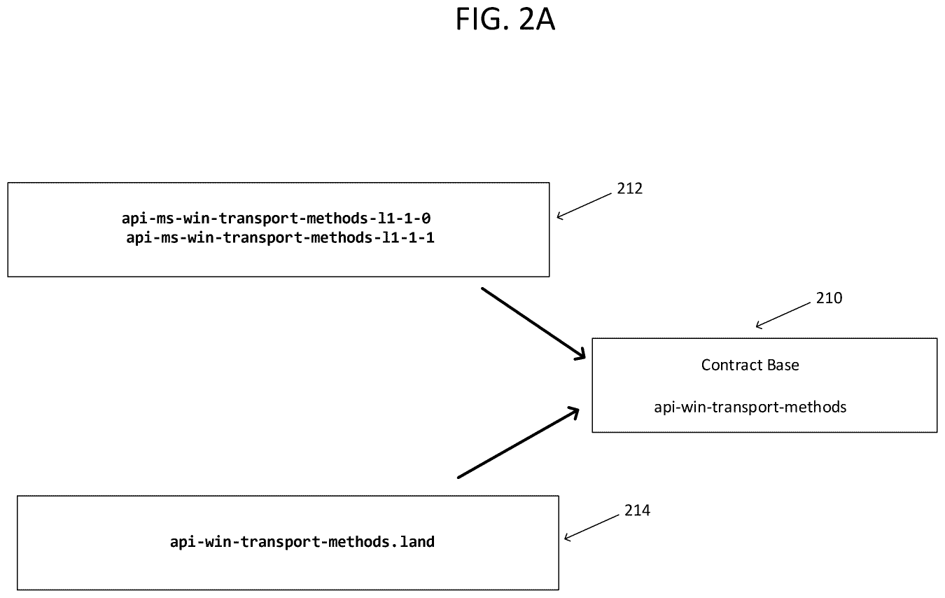

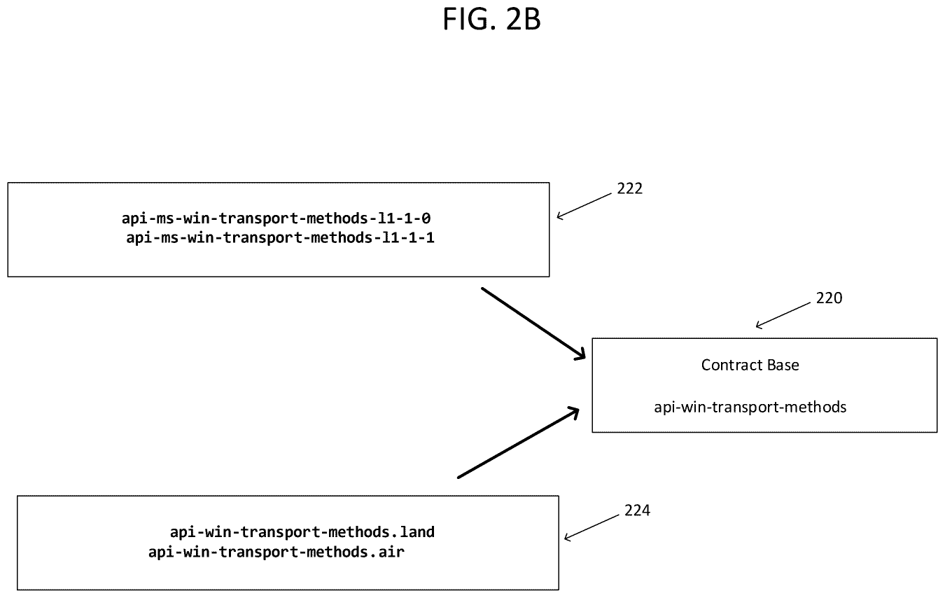

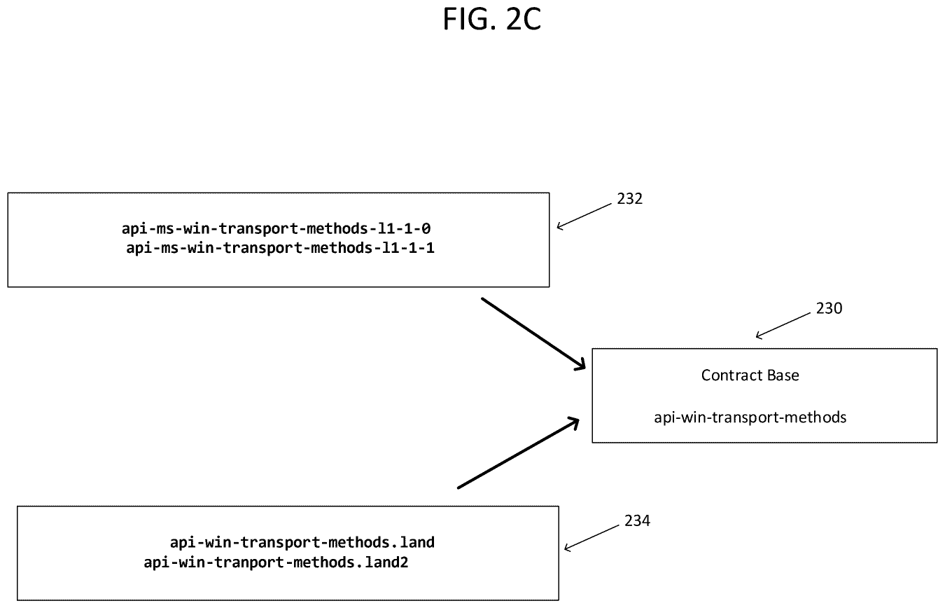

FIGS. 2A-2C illustrate examples of mappings between a modular API namespace and the contract of that namespace.

In some embodiments, a contract 210 initially written utilizing the semantic versioning nomenclature of an API namespace 212 can be re-written to leverage the nomenclature of the modular API namespace 214, as disclosed herein. FIG. 2A illustrates an example of the created contract 210 that can be mapped to an API namespace 212 and/or a modular API namespace 214, as disclosed herein. An example of syntax for creating the contract 210 utilizing semantic versioning for the API namespace 212 can include:
@[contract(api-ms-win-transport-methods-l1)];
@[win7]
void Crawl(int speed);
@[win7]
void Walk(int speed);
@[win8]
void Run(int speed);

In this contract 210, there are three implemented APIs (“crawl”, “walk”, and “run”) in namespace. The first two APIs (“crawl”, “walk”) were authored at a previous OS release (e.g., win7), with the third API (“run”) may have been added to the contract 210 in a subsequent OS release (e.g., win8). An example of two variants of the API namespace 212 that the contract 210 may produce includes:
api-ms-win-transport-methods-l1-1-0
api-ms-win-transport-methods-l1-1-1

In the pre-existing APIs, where the contract 210 was written utilizing the semantic versioning of the API namespace 212, the contract 210 could be re-written utilizing the syntax for a modular API namespace 214 with a single modular API namespace (API set group) for all three APIs in the defined group. An example of syntax for re-writing the contract 210 utilizing semantics for the modular API namespace 214 can include:
@[Contract(api-win-transport-methods)];
@[ContractGroup(Land)];
@[Group(Land)]
void Crawl(int speed);
@[Group(Land)]
void Walk(int speed);
@[Group(Land)]
void Run(int speed);

The contract 210 can produce a single group variant. An example of the modular API namespace 214 that the contract 210 may produce includes:
api-win-transport-methods.land

Accordingly, all three of the APIs are in the single defined API set group (“.land”), which allows the modular API namespace 214 to be mapped to the contract 210 in a manner that is decoupled from the version.

In an example of a contract revision, an existing contract 220 can be revised to include a new API, for instance, utilizing the semantic versioning nomenclature of an API namespace 222. FIG. 2B illustrates an example of the revised contract 220 that can be mapped to an API namespace 222 and/or a modular API namespace 224, as disclosed herein. An example of syntax for revising the contract 220 utilizing semantic versioning for the API namespace 222 can include:
@[win8]
void Fly(int speed);

With the addition of an API (“fly”) to the contract in a subsequent OS release (e.g., win8) in the contract revision, the contract 220 may produce two variants to the API namespace 222. An example of two variants of the API namespace 222 that the revised contract 220 may produce includes:
api-ms-win-transport-methods-l1-1-0
api-ms-win-transport-methods-l1-1-1

In contrast, the same contract revision can be executed to revise the contract 220 utilizing the syntax for a modular API namespace 224. By leveraging a modular API namespace 224, the contract revision could be accomplished by adding a new “ContractGroup” element to the contract definition. An example of syntax for revising the contract 220 utilizing semantics for the modular API namespace 224 can include:
@[ContractGroup(Air)];
@[Group(Air)]
void Fly(int speed);

Accordingly, the contact revision adding the new API (“fly”) can include two defined groups (“.land” and “.air”) of API sets in the modular API namespace 224 that are mapped to the contract 220 in a manner that is decoupled from the version. An example of the group variants of the modular API namespace 224 that the revised contract 220 may produce includes:
api-win-transport-methods.land
api-win-transport-methods.air

In another example of a contract revision, a group revision for an API related to a pre-existing group in the contract can be executed. FIG. 2C illustrates an example of a revised group in the contract 230 that can be mapped to an API namespace 232 and/or a modular API namespace 234, as disclosed herein. Referring back to the previous example, three APIs (“crawl”, “walk”, and “run”) can be a group of APIs defined by the contract group (“.land”). An example of syntax for the contact 230 utilizing semantics for the modular API namespace 234 can include:
@[Group(Land)]
void Crawl(int speed);
@[Group(Land)]
void Walk(int speed);
@[Group(Land)]
void Run(int speed);

Groups may not be related and/or connected via a sequence of cascading versions in the nomenclature for modular API namespaces (as is done in semantic versioning). But it is also possible within the nomenclature to indicate a logical relationship between groups using a numbering scheme. If in this example, the last API (“run”) was added after the group (.land”) was already created, then the contract revision may involve several considerations, including: by convention, the API group (“.land”) should not be modified after it has been made public; and there may be no infrastructure for revisions of the API group within the namespace, so a new group can be created. In this case, the new group may be named such that there a contextual connection within the nomenclature. For example, an appended integer (<GroupName><N>) can be utilized to create this contextual connection between groups utilizing the modular API namespace 234. An example of syntax for the contract revision of contract 230 utilizing the API namespace 224 can include:
@[ContractGroup(Land)];
@[Group(Land)]
void Crawl(int speed);
@[Group(Land)]
void Walk(int speed);
@[ContractGroup(Land2)];
@[Group(Land2)]
void Run(int speed);

The new modular API namespace (“.land2”) for the new group is decoupled from the group of APIs in the previous modular API namespace (“.land”) with respect to software implementation. There is a flexibility that may be achieved by modularly adding the new API to the contract 230 utilizing the modular API namespace 234. The modular API namespace 234 can enable the subsequent group (“.land2”) to be individually backported (without the previous group “.land”). Thus, the modular API namespace 234 can be leveraged to create a contextual connection between API set groups (as revised) in the contract 230 that can maintain the modularity of independent implementation for APIs (e.g., groups of APIs can have a decoupled implementation).

In some embodiments, a contract can be created in a manner that ties features related to development of the APIs (e.g., implementation state) to the different API set groups (in the defined contract) by leveraging modular API namespaces. An example syntax for implementing a contract for groups of APIs including development related features can include:
@[Contract(api-transport-methods)];
@[ContractGroup(Air),
   stagedFeatureHeaderName(“fs-tm.h”),
   stagedFeatureClassName(“Feature_Plane”)];
      @[Group(Air)]
      void Fly(int speed);
      @[ContractGroup(Sea),
         stagedFeatureHeaderName(“fs-tm.h”),
         stagedFeatureClassName(“Feature_Boat”)];
      @[Group(Sea)]
      void Sail(int speed);
      @[ContractGroup(Space),
         stagedFeatureHeaderName(“fs-tm.h”),
         stagedFeatureClassName(“Feature_Rocket”)];
      @[Group(Space)]
      void BlastOff(int speed);

Thus, there are development features for the API set groups that can be queried (utilizing the querying mechanism) corresponding to their implementation based on the defined link between API set groups and development features in the contract. Table 1 below includes examples of data that can be used to query for implementation of the groups of APIs in the contract.

TABLE 1

| API | API set group full name | Development Feature |
|---|---|---|
| Fly | api-transport-methods-air | Feature_Plane |
| Sail | api-transport-methods-sea | Feature_Boat |
| Blastoff | api-transport-methods-space | Feature_Rocket |

There may be circumstances where an API set group has been released and made public. Subsequently, new functionality to the behavior of APIs within the group can be rolled out. In this example, there are no new APIs that are being defined, but changes to the implementation of the APIs. Leveraging the modular API namespace nomenclature to support such modular adaptability of groups of APIs may be able to dynamically improve already existing (and released) APIs, such as in the case of an evolving OS. In some embodiments, an existing contract utilizing modular API namespaces can implement a development flag tied to API set group that can indicate features related to development of the APIs (e.g., implementation state). An example syntax implementing a contract including a feature flag corresponding to an API set group can include:
@[Contract(api-transport-methods)];
@[ContractGroup(Space)];
@[ContractGroup(Warp), Velocity(“fs-tm.h”, “Feature_Warp_Drive”)];
@[Group(Space)]
void BlastOff(int speed);

The created contract may produce two API set groups (“api-transport-methods.space” and “api-transport-methods.warp”). In an operational example, at the time of release, there can be a feature flag (“Feature_Warp_Drive”) that gated the second API set group (“.warp”). But, it is possible for the feature flag to be removed after a change in the implementation state of the APIs (e.g., going to an AlwaysEnabled state). The querying mechanism, as disclosed herein, is configured to use that the first API set group (“.space”) of the contract to query in order to determine availability, which may not be based on the state of the feature key. Because all of the groups in the contract share the same implementation host, there is a capability of the querying mechanism to directly query the second API set group (“.warp”), which has the effect of querying for the same host of the original group, but also the new feature flag. Thus, the querying mechanism can leverage the defined feature flag to determine whether a particular feature associated with the implementation of an API set group is enabled.

The modular API namespace, as disclosed herein, enables modularity with respect to implementation of components and/or functions of API set groups. Instead of hard-linking applications to a specific dynamic link libraries (implementing the functions and/or components for a contract), the ability to specify API set groups provides a flexible and modular mechanism where the components and/or functions (defined by the contract) are mapped to a group of APIs (e.g., API set group). Thus, modular API namespaces provide a layer of abstraction by decoupling applications and functions from direct dependencies on system dynamic link libraries. At runtime, the modular API namespace links the group of APIs in the namespace to the proper contract (e.g., implementation DLL) in a manner that provides enhanced compatibility with evolving operating systems, increases modularity in API implementation, and decouples APIs from semantic versioning.

FIG. 3 depicts an example method 300 for implementing a query of a modular API namespace. The method 300 can be implemented by a querying mechanism implemented on a computer system (e.g., as shown in FIG. 1A). The querying mechanism may be implemented as a querying API (e.g., IsApiSetImplemented(“modular api namespace”)) that is configured to execute a set of functions to retrieve information related to the software development of a modular API namespace, such as the presence and/or implementation state. For example, the method 300 can be executed by the querying mechanism (e.g., querying API) to be able to query whether a group of APIs are mechanically available by export in a host binary and enabled by the system.

In the example method 300 of FIG. 3, at operation 305, a processor receives a query for a modular API namespace. For example, an application can call a querying API to retrieve data about the implementation state of an API set, as indicated by an API namespace or a modular API namespace. The querying API can receive input parameters to define the APIs to be searched in the query, where the input parameters can be a modular API namespace utilizing the modular grouping nomenclature disclosed herein. The querying API can also receive input parameters in the form of API namespaces utilizing the semantic versioning nomenclature. The querying API can be configured to execute querying of both semantic versioning contract names, and API groups defined by a modular API namespace. For example, at operation 305, an application can perform a function call to execute a query with an example syntax:
IsApiSetImplemented(“api-abcdef.class”);
   In the example, the input parameters include a modular API namespace (“api-abcdef.class”) indicating a particular API set group (“.class”). The querying API may be configured to parse the input parameters and translate them into database queries and/or search operations.

At operation 310, a conditional check is executed to determine if the query is for an API namespace or a modular API namespace. Operation 310 can involve determining if the input parameters include a ContractGroup element, which would indicate querying of an API set group represented by a modular API namespace. If operation 310 determines that the input parameter is an API namespace utilizing semantic versioning (e.g., input parameter of the query has no ContractGroup element), the method 300 queries for an API set (“No” in FIG. 3) and proceeds to operation 315 to perform a query of an API set.

At operation 315, the querying API can query the major/minor version of a contract for a supporting host associated with the queried API namespace. An example syntax to query an API namespace can include:
IsApiSetImplemented(“api-xyz-l1-1-3”);

At operation 320, the query returns the implementation state of the API set indicated by the API namespace. The querying API can return TRUE, which indicates that the APIs in revisions 1-0 through 1-3 are available as exports in the host (e.g., API set is implemented). Alternatively, the querying API can return FALSE, which indicates that the APIs are not available as exports in the host (e.g., API set is not implemented).

Referring back to operation 310, if it is determined that the input parameter is a modular API namespace (e.g., input parameter of the query includes a ContractGroup element), the method 300 queries for a group of APIs (“Yes” in FIG. 3) and proceeds to operation 325 to perform a query of an API set group.

At operation 325, the development key of the modular API namespace is determined. As previously discussed, the modular API namespace is leveraged to link a group of APIs to a development key. The corresponding development key indicates an implementation state of the API set group. For example, the call to the querying API can search a mapping of the ContractGroup element included in the received modular API namespace to determine the linked development key, which indicates the implementation state for the APIs (in the API set group) at runtime (for the appropriate implementation DLL).

At operation 330, the querying API returns the implementation state of the queried API set group (as indicated by the received modular API namespace) based on the development key. The return value reflects the implementation state indicated by the development key linked to the API set group (ContractGroup element). If the querying API returns the value TRUE, then it indicates that all the functions in the group (“.class”) within the API set are available as exports in the host, and the implementation of the group is enabled (e.g., implemented, enabled). If the querying API returns the value FALSE, then it can indicate the API set group (“.class”) is available as exports in the host, but the functions of the group are disabled (e.g., implemented, disabled). In some embodiments, the querying API can return an implement state related to runtime presence of APIs based on the development key of the “parent” ContractGroup element for the API set group. If the querying API returns a FALSE value for the runtime presence of the API group set it can indicate that the group is not available as exports in the host (e.g., not implemented). The method 300 implements querying of a modular API namespace, which allows an implementation state of an API set group at runtime to be reliably determined for the nuanced implementations of modular API groups (e.g., functions of an API set group can be incrementally updated), for example in the environment of an evolving OS.

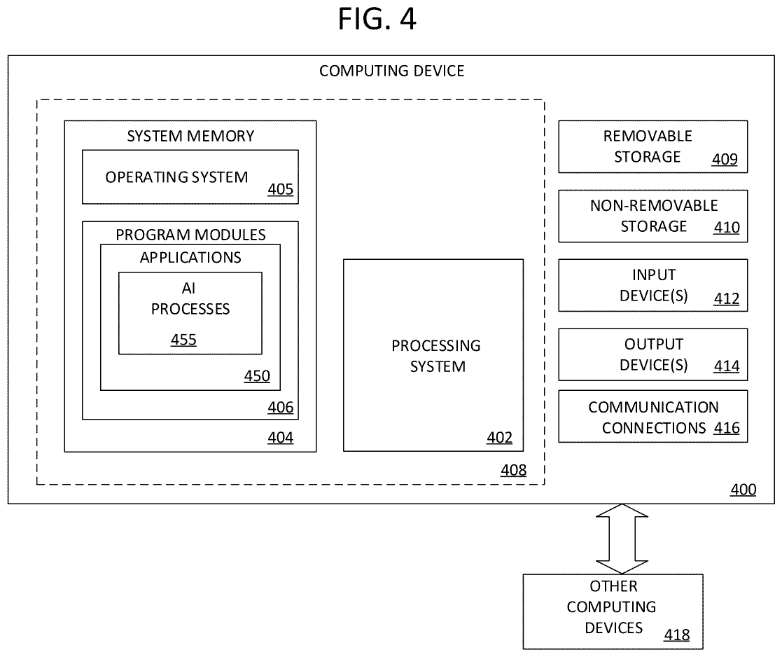

FIG. 4 and the associated description provide a discussion of a variety of operating environments in which examples of the present techniques may be practiced. However, the devices and systems illustrated and discussed with respect to FIG. 4 are for purposes of example and illustration and is not limiting of a vast number of computing device configurations that may be utilized for practicing aspects of the present techniques, described herein. FIG. 4 is a block diagram illustrating physical components (i.e., hardware) of a computing device 400 with which examples of the present disclosure may be practiced. The computing device components described below may be suitable for a client device running the web browser discussed above. In a basic configuration, the computing device 400 may include a processing system 402 including at least one processing unit and a system memory 404. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program modules 406 suitable for running software applications 450. The software applications 450 may be any of the applications and/or processes discussed herein for handling the distribution and execution of the AI models and/or training sets discussed herein. Such applications and processes may be referred to collectively as AI processes 455.

The operating system 405, for example, may be suitable for controlling the operation of the computing device 400. Furthermore, aspects of the present techniques may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing system 402, the program modules 406 may perform processes including, but not limited to, one or more of the operations of the methods and/or data flows illustrated in the Figures. Other program modules that may be used in accordance with examples of the present techniques and may include applications such as electronic mail and contacts applications, word processing applications, spreadsheet applications, database applications, slide presentation applications, drawing or computer-aided application programs, etc.

Furthermore, examples of the present techniques may be practiced in an electrical circuit comprising discrete electronic elements, packaged or integrated electronic chips containing logic gates, a circuit utilizing a microprocessor, or on a single chip containing electronic elements or microprocessors. For example, examples of the present techniques may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 400 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 400 may also have one or more input device(s) 412 such as a keyboard, a mouse, a pen, a sound input device, a touch input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As will be understood from the present disclosure, one aspect of the technology discussed herein relates to a system for implementing modular API namespaces, the system comprising: at least one processor; a memory device storing instructions, which, in response to being executed by the at least one processor, cause the at least one processor to perform: receiving a modular application programming interface (API) namespace defining a group of APIs; accessing a map associating the modular API namespace to a contract comprising computer-executable components; identifying, based on the map, at least one computer-executable component for the group of APIs; and loading the at least one identified computer-executable component.

In one example, the modular API namespace comprises a contract base name and a contract group name.

In one example, the contract base name defines a host binary associated with the modular API namespace.

In one example, the contract group name indicates the group of APIs defined by the modular API namespace.

In one example, the modular API namespace corresponds to a development key.

In one example, in the system, the memory device comprises instructions, which cause the at least one processor to further perform associating an implementation state of the contract group name at runtime to the development key.

In one example, the implementation state of the contract group name comprises at least one of: not implemented, implemented and enabled, or implemented and disabled.

In one example, in the system, the memory device comprises instructions, which cause the at least one processor to further perform querying the modular API namespace for the implementation state of the contract group name at runtime.

In one example, in the system, the memory device comprises instructions, which cause the at least one processor to further perform creating an additional modular API namespace to revise the contract, the additional modular API namespace defining an additional group of APIs.

In one example, the creating an additional modular API namespace maps the additional group of APIs to the revised contract.

In one example, in the system, the memory device comprises instructions, which cause the at least one processor to further implement a loader accessing the map and loading the at least one identified computer-executable component.

In one example, in the system, the memory device comprises instructions, which cause the at least one processor to further implement an operating system that dynamically updates the at least one computer-executable component for the group of APIs.

In one example, in the system, the memory device comprises instructions, which cause the at least one processor to further perform: receiving an API namespace; accessing the map associating the API namespace to a contract comprising computer-executable components; identifying, based on the map, at least one computer-executable component for the API namespace; and loading the at least one identified computer-executable component.

In one example, the API namespace comprises a version.

As will be understood from the present disclosure, one aspect of the technology discussed herein relates to a computer readable storage medium implementing modular API namespaces, the computer readable storage medium storing computer-executable instructions, that, when executed by a processor, causes the processor to: receive a modular application programming interface (API) namespace defining a group of APIs; access a map associating the modular API namespace to a contract comprising computer-executable components; identify, based on the map, at least one computer-executable component for the group of APIs; and load the at least one identified computer-executable component.

In one example, the modular API namespace comprises a contract base name and a contract group name.

In one example, the contract group name indicates the group of APIs defined by the modular API namespace.

In one example, the computer readable storage medium stores computer-executable instructions, that, when executed by a processor, further causes the processor to: receive an API namespace comprising a version; access the map associating the API namespace to a contract comprising computer-executable components; identify, based on the map, at least one computer-executable component for the API namespace; and load the at least one identified computer-executable components.

As will be understood from the present disclosure, one aspect of the technology discussed herein relates to a computer-implemented method implementing modular API namespaces, the method comprising: receiving a query of a modular application programming interface (API) namespace defining a group of APIs; determining a developmental key of the modular API namespace, wherein the development key is mapped to the group of APIs; and returning, in response to the received query, an implementation state of the modular API namespace based on the developmental key.

In one example, the implementation state comprises at least one of: not implemented, implemented and enabled, or implemented and disabled.

Aspects of the present techniques, for example, are described above with reference to block diagrams and/or operational illustrations of methods, systems, and computer program products according to aspects of the present techniques. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more examples provided in this application are not intended to limit or restrict the scope of the present techniques as claimed in any way. The aspects, examples, and details provided in this application are considered sufficient to convey possession and enable others to make and use the best mode of present techniques. The present techniques should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the present techniques.

We claim:

1. A system, comprising:
at least one processor;
a memory device storing instructions, which, in response to being executed by the at least one processor, cause the at least one processor to perform:
receiving a modular application programming interface (API) namespace defining a group of APIs;
accessing a map associating the modular API namespace to a contract comprising computer-executable components;
identifying, based on the map, at least one computer-executable component for the group of APIs; and
loading the at least one identified computer-executable component.

2. The system of claim 1, wherein the modular API namespace comprises a contract base name and a contract group name.

3. The system of claim 2, wherein the contract base name defines a host binary associated with the modular API namespace.

4. The system of claim 2, wherein the contract group name indicates the group of APIs defined by the modular API namespace.

5. The system of claim 4, wherein the modular API namespace corresponds to a development key.

6. The system of claim 5, wherein the memory device comprises instructions, which cause the at least one processor to further perform associating an implementation state of the contract group name at runtime to the development key.

7. The system of claim 5, wherein the implementation state of the contract group name comprises at least one of: not implemented, implemented and enabled, or implemented and disabled.

8. The system of claim 7, wherein the memory device comprises instructions, which cause the at least one processor to further perform querying the modular API namespace for the implementation state of the contract group name at runtime.

9. The system of claim 1, wherein the memory device comprises instructions, which cause the at least one processor to further perform creating an additional modular API namespace to revise the contract, the additional modular API namespace defining an additional group of APIs.

10. The system of claim 9, wherein the creating an additional modular API namespace maps the additional group of APIs to the revised contract.

11. The system of claim 1, wherein the memory device comprises instructions, which cause the at least one processor to further implement a loader accessing the map and loading the at least one identified computer-executable component.

12. The system of claim 1, wherein the memory device comprises instructions, which cause the at least one processor to further implement an operating system that dynamically updates the at least one computer-executable component for the group of APIs.

13. The system of claim 1, wherein the memory device comprises instructions, which cause the at least one processor to further perform:
receiving an API namespace;
accessing the map associating the API namespace to a contract comprising computer-executable components, identifying, based on the map, at least one computer-executable component for the API namespace; and
loading the at least one identified computer-executable component.

14. The system of claim 13, wherein the API namespace comprises a version.

15. A computer readable storage medium, storing computer-executable instructions, that, when executed by a processor, causes the processor to:
receive a modular application programming interface (API) namespace defining a group of APIs;
access a map associating the modular API namespace to a contract comprising computer-executable components;
identify, based on the map, at least one computer-executable component for the group of APIs; and
load the at least one identified computer-executable component.

16. The computer-readable storage medium of claim 15, wherein the modular API namespace comprises a contract base name and a contract group name.

17. The computer-readable storage medium of claim 16, wherein the contract group name indicates the group of APIs defined by the modular API namespace.

18. The computer readable storage medium of claim 15, wherein the computer readable storage medium stores computer-executable instructions, that, when executed by a processor, further causes the processor to:
receive an API namespace comprising a version;
access the map associating the API namespace to a contract comprising computer-executable components;
identify, based on the map, at least one computer-executable component for the API namespace; and
load the at least one identified computer-executable components.

19. A computer-implemented method, comprising:
receiving a query of a modular application programming interface (API) namespace defining a group of APIs;
determining a developmental key of the modular API namespace, wherein the development key is mapped to the group of APIs; and
returning, in response to the received query, an implementation state of the modular API namespace based on the developmental key.

20. The method of claim 19, wherein the implementation state comprises at least one of: not implemented, implemented and enabled, or implemented and disabled.
